(19) United States
(12) Patent Application Publication
(10) Pub. No.: US 2025/0154357 A1
(43) Pub. Date: May 15, 2025

(54) INTERPENETRATING NETWORK TYPE ORGANIC SILICON RESIN AND PREPARATION METHOD THEREFOR

(71) Applicant: HUBEI LONGSHENG SIHAI NEW MATERIALS CO., LTD., Hubei (CN)

(72) Inventors: Ling SHAO, Hubei (CN); Fan YANG, Hubei (CN); Jiaquan GONG, Hubei (CN); Yinbo PENG, Hubei (CN); Yu ZHOU, Hubei (CN)

(21) Appl. No.: 19/023,496

(22) Filed: Jan. 16, 2025

Related U.S. Application Data
(63) Continuation of application No. PCT/CN2023/141434, filed on Dec. 25, 2023.

(30) Foreign Application Priority Data
Jan. 3, 2023 (CN) 202310001425.3

(51) Int. Cl. C08L 83/04; C08G 63/183; C08G 77/08; C08K 5/5425

(52) U.S. Cl. CPC C08L 83/04; C08G 63/183; C08G 77/08; C08K 5/5425; C08L 2205/035; C08L 2205/04

(57) ABSTRACT

Disclosed in the present invention are an interpenetrating network type organic silicon resin and a preparation method therefor. The raw materials of the interpenetrating network type organic silicon resin include a polysiloxane oligomer, an alkoxysilane, a polyester resin, an epoxy resin, an acrylic resin, a polymerization reaction catalyst, a polymerization reaction solvent and an amino resin, wherein the mass ratio of the polysiloxane oligomer to the polyester resin to the epoxy resin to the acrylic resin is 1:(0.25-0.96):(0.05-0.64):(0.10-0.81); the mass fraction of the alkoxysilane in the polysiloxane oligomer is 0.5-18%; and the amino resin accounts for 1-25% of the total mass of the polysiloxane oligomer, the polyester resin, the epoxy resin and the acrylic resin.

### CROSS-REFERENCE TO RELATED APPLICATIONS

The present application is a continuation of International Application No. PCT/CN2023/141434, with an international filing date of Dec. 25, 2023, which is based upon and claims priority to Chinese Patent Application No. 202310001425.3, filed on Jan. 3, 2023, the entire contents of all of which are incorporated herein by reference.

### TECHNICAL FIELD

The present invention relates to the field of organic silicon resin technology, particularly to an interpenetrating network type organic silicon resin and preparation method therefor.

### BACKGROUND

Organic silicon resin has good characteristics such as high and low temperature resistance, hydrophobicity, electrical insulation, and weather resistance, and has good adhesion to metals such as iron, aluminum, silver, and tin, and is also easy to adhere to glass and ceramics. However, it has poor adhesion to non-ferrous metals, especially copper materials.

### SUMMARY

The purpose of the present invention is to overcome the above-mentioned technical shortcomings, and provide an interpenetrating network type organic silicon resin and preparation method therefor to solve the technical problem of poor adhesion of organic silicon resin to copper material in the prior art.

In order to achieve the above technical purpose, the technical solution of the present invention provides an interpenetrating network type organic silicon resin:

The raw materials of interpenetrating network type organic silicon resin include a polysiloxane oligomer, an alkoxysilane, a polyester resin, an epoxy resin, an acrylic resin, a polymerization reaction catalyst, a polymerization reaction solvent and an amino resin, wherein the mass ratio of the polysiloxane oligomer to the polyester resin to the epoxy resin to the acrylic resin is 1:(0.25-0.96):(0.05-0.64):(0.10-0.81); the mass fraction of the alkoxysilane in the polysiloxane oligomer is 0.5-18%; and the amino resin accounts for 1-25% of the total mass of polysiloxane oligomer, polyester resin, epoxy resin and acrylic resin.

In further, the structural formula of the alkoxysilane is R¹Si(OR²)₃;

R¹ is a hydrocarbon group; R² is methyl, ethyl, propyl, or butyl.

In further, the structural formula of polysiloxane oligomer is: (R³SiO_{3/2})ₐ·(R⁴R⁵SiO_{2/2})_{b}·(SiO₂)_{c}·R⁶.

R³SiO_{3/2}, R⁴R⁵SiO_{2/2}, and SiO₂ represent T unit siloxanes, D unit siloxanes, and Q unit siloxanes, respectively; R³, R⁴, and R⁵ are the same or different alkyl, aryl, or vinyl groups, R⁶ is an alkoxy functional group or hydroxyl group, and a, b, and c are integers greater than or equal to 0 but not all 0.

In further, the hydroxyl content of polyester resin is 5%-18%, the solid content is 80%, the acid value is less than 10 mg KOH/g, and the number average molecular weight is 1000-15000;

The epoxy resin includes bisphenol A type epoxy resin, with an epoxy equivalent of 100-6000 g/eq.

In further, the acrylic resin includes a thermosetting hydroxy acrylic resin, with an acid value of less than 20 mg KOH/g and a hydroxy value of 50-260 mg KOH/g.

In further, the mass fraction of polymerization reaction catalyst in polysiloxane oligomers is 0.1%-1.5%; the polymerization reaction catalyst is a mixture of at least three metal organic carboxylate, titanate, and organic tin catalysts.

In further, the metal carboxylate includes one or more of zinc cycloalkanoate, zinc isooctanoate, cobalt cycloalkanoate, cobalt isooctanoate, lead isooctanoate, lead cycloalkanoate, lead octanoate, manganese cycloalkanoate, and stannous octanoate; titanates include one or more of tetrabutyl titanate and tetraisopropyl titanate; organic tin catalysts include one or more of dibutyltin dilaurate, dioctyltin dilaurate, dibutyltin dibutanoate, dioctyltin diacetate, dibutyltin diacetate, and dibutyltin Bis(2,4-pentanedionate).

In further, the polymerization reaction solvent accounts for 10-60% of the total mass of polysiloxane oligomer, polyester resin, epoxy resin, and acrylic resin; the polymerization reaction solvent includes a mixed solvent composed of any two or more of cyclohexanone, n-butanol, butyl acetate, ethyl acetate, PMA, CAC, IMMP, MIBK, isophorone, xylene, DBE solvent, isopropanol, acetone, toluene, and diethyl ether.

The technical solution of the present invention also provides a preparation method for interpenetrating network type organic silicon resin, including the following steps:
(1) Mix in proportion polysiloxane oligomers, alkoxysilane, polyester resin, epoxy resin, acrylic resin, polymerization reaction catalyst, and first polymerization reaction solvent to obtain a mixture;
(2) Pre-react the mixture at 50-100° C. for 2-6 hours, then heat to 130-155° C. for 4-8 hours, add the second reaction polymerization solvent and cool to 50-90° C., add amino resin, and then add the third reaction polymerization solvent to adjust the solid content to 45-55%, and finally obtain the interpenetrating network type organic silicon resin.

In further, the preparation procedure of polysiloxane oligomers in step (1) includes the following steps:
Mix chlorosilane monomers evenly and add them dropwise to a mixture of alcohol, water, and solvent for simultaneous alcoholysis and hydrolysis reactions;
After the reaction is complete, separate the acidic water layer, wash the silanol with water until neutral, decolorize and filter, and evaporate a portion of the solvent under reduced pressure to a solid content of 60-70% to obtain the polysiloxane oligomer.

In further, in terms of molar percentage, the raw materials of chlorosilane monomer include 25-80% of R³SiCl₃, 8-60% of R⁴R⁵SiCl₂, and 0-15% of SiCl₄.

In further, the ratio of the total mass of alcohol and solvent to the mass of chlorosilane monomer is 2-9:1.

In further, the solvent includes one or more of toluene, xylene, PMA, and CAC.

In further, alcohols include one or more of methanol, ethanol, isopropanol, and n-butanol.

In further, the mass ratio of solvent to alcohol is 2-60:1.

In further, water is 1-8 times the mass of chlorosilane monomer.

In further, in step (2), the solid content is adjusted to 45-55%.

Compared with the prior art, the beneficial effects of the present invention include the following:

The preparation process and flow disclosed in the present invention are simple. Polysiloxane oligomers prepared by co alcoholysis and hydrolysis of chlorosilane monomers and alkoxysilane are copolymerized with alkoxysilane, polyester resin, epoxy resin, and acrylic resin. Under the action of polymerization reaction catalyst, low-temperature pre-reaction is carried out first, and then polymerization is carried out at high temperature to ensure smooth polymerization reaction. The prepared interpenetrating network type organic silicon resin has a more uniform molecular weight and good adhesion to non-ferrous metals, especially copper materials or copper alloys, and also has improved adhesion to metal materials based on the advantages of organic resin and organic silicon resin; The addition of amino resin significantly improves the performance of resin by improving its drying performance and increasing its hardness. The adhesive force of the organic silicon resin to non-ferrous metals, especially metal materials such as copper parts, copper materials, copper alloys and aluminum products, is significantly improved, such that non-ferrous metals are protected, and the service life of non-ferrous metals is prolonged.

### DETAILED DESCRIPTION OF THE EMBODIMENTS

In order to make the purpose, technical solution, and advantages of the present invention clearer and more understandable, detailed explanations of the present invention will be further provided below in conjunction with the embodiments. It should be appreciated that the specific embodiments described herein are only used to explain the present invention and are not intended to limit the present invention.

In order to addresses the problem of poor adhesion between organic silicon resin and non-ferrous metals, especially copper parts, copper materials, and copper alloys, the present invention provides an interpenetrating network type organic silicon resin for improving the performance of organic silicon resin and a preparation method therefor, significantly improving the adhesion to metal materials, especially copper parts, copper materials, and copper alloys, providing protection and extending their service life.

The present invention provides an interpenetrating network type organic silicon resin, and its raw materials include a polysiloxane oligomer, an alkoxysilane, a polyester resin, an epoxy resin, an acrylic resin, a polymerization reaction catalyst, a polymerization reaction solvent and an amino resin;

The mass ratio of the polysiloxane oligomer to the polyester resin to the epoxy resin to the acrylic resin is 1:(0.25-0.96):(0.05-0.64):(0.10-0.81) and, preferably, the mass ratio is (0.25-0.60):(0.06-0.20):(0.12-0.25).

Preferably, the mass fraction of the alkoxysilane in the polysiloxane oligomer is 0.5-18%, and preferably 5-12%, and more preferably, the structural formula of the alkoxysilane is R¹Si(OR²)₃;

R¹ is a hydrocarbon group and, preferably, C₁-C₅ hydrocarbon group; R² is methyl, ethyl, propyl, or butyl.

Preferably, the polysiloxane oligomer has a weight average molecular weight of 800-6500, with the structural formula of: (R³SiO_{3/2})ₐ·(R⁴R⁵SiO_{2/2})_{b}·(SiO₂)_{c}·R⁶.

R³SiO_{3/2}, R⁴R⁵SiO_{2/2}, and SiO₂ represent T unit siloxanes, D unit siloxanes, and Q unit siloxanes, respectively; R³, R⁴, and R⁵ are the same or different alkyl, aryl, or vinyl groups, R⁶ is an alkoxy functional group, such as methoxy, ethoxy, propoxy, butoxy, etc. or hydroxyl group, and a, b, and c are integers greater than or equal to 0 but not all 0.

Preferably, the polyester resin is formed by the condensation reaction of polyols and polyacids under the action of organic tin catalyst, and the polyester resin has a hydroxyl content of 5%-18%, a solid content of 80%, an acid value of less than 10 mg KOH/g, and a number average molecular weight of 1000-15000.

Preferably, the epoxy resin is mainly bisphenol A type epoxy resin with an epoxy equivalent of 100-6000 g/eq, and its chemical structure is:

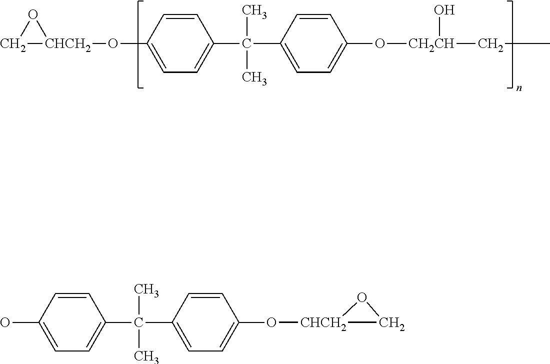

Preferably, the acrylic resin is mainly a thermosetting hydroxy acrylic resin, with an acid value of less than 20 mg KOH/g and a hydroxyl value of 50-260 mg KOH/g.

Preferably, the mass fraction of polymerization reaction catalyst in polysiloxane oligomer is 0.1%-1.5%, and preferably 0.3%-0.8%; more preferably, the polymerization reaction catalyst is prepared in proportion by three or more metal organic carboxylate, titanate, and organic tin catalysts. More preferably, the metal organic carboxylate includes one or more of zinc cycloalkanoate, zinc isooctanoate, cobalt cycloalkanoate, cobalt isooctanoate, lead isooctanoate, lead cycloalkanoate, lead octanoate, manganese cycloalkanoate, stannous octanoate; titanates include one or more of tetrabutyl titanate and tetraisopropyl titanate; organic tin catalysts include one or more of dibutyltin dilaurate, dioctyltin dilaurate, dibutyltin dibutanoate, dioctyltin diacetate, dibutyltin diacetate, and dibutyltin Bis(2,4-pentanedionate).

Preferably, the total amount of the polymerization reaction solvent accounts for 10-60% of the total mass of polysiloxane oligomer, polyester resin, epoxy resin, and acrylic resin; the polymerization reaction solvent can be added step by step as needed, and when it is simply added as a solvent for mixing reaction materials, cooling down and solid content adjustment are required during the reaction. More preferably, the polymerization reaction solvent includes a mixed solvent composed of any two or more of cyclohexanone, n-butanol, butyl acetate, ethyl acetate, PMA, CAC, MMP, MIBK, isophorone, xylene, DBE solvent, isopropanol, acetone, toluene, and diethyl ether.

Preferably, the amino resin accounts for 1-25% of the total mass of polysiloxane oligomer, polyester resin, epoxy resin and acrylic resin, and preferably, 3-10%. More preferably, amino resin is a mixture of one or two of melamine formaldehyde resin and urea formaldehyde resin.

The present invention also provides a method for preparing an interpenetrating network type organic silicon resin, including the following steps:
(1) Mix in proportion the polysiloxane oligomers, alkoxysilane, polyester resin, epoxy resin, acrylic resin, polymerization reaction catalyst, and the first polymerization reaction solvent to obtain a mixture;
(2) Pre-react the mixture at 50-100° C. for 2-6 hours, then heat to 130-155° C. for 4-8 hours, add the second reaction polymerization solvent and cool to 50-90° C., add amino resin, mix evenly, and then add the third polymerization reaction solvent to adjust the solid content to 45-55%, and finally obtain the colorless to light yellow transparent interpenetrating network type organic silicon resin described in the present invention.

Preferably, the preparation method of the polysiloxane oligomer described in the present invention is described as follows:
A. Mix chlorosilane monomers evenly and add them dropwise to a mixture of alcohol, water, and solvent for simultaneous alcoholysis and hydrolysis reactions; the reaction temperature is 15-55° C.;
B. After the reaction is complete, separate the acidic water layer, wash the silanol with water until neutral, decolorize and filter, and evaporate a portion of the solvent under reduced pressure to a solid content of 65% to obtain the polysiloxane oligomer.

More preferably, the raw materials of chlorosilane monomer include R³SiCl₃, R⁴R⁵SiCl₂ and SiCl₄, wherein R³SiCl₃ accounts for, in terms of molar percentage, 25-80% of the raw materials of chlorosilane monomer, more preferably 50-75%; R⁴R⁵SiCl₂ accounts for, in terms of molar percentage, 8-60% of the raw materials of chlorosilane monomer, more preferably 25-50%; SiCl₄ accounts for, in terms of molar percentage, 0-15% of the raw materials of chlorosilane monomer, more preferably 0-5%. R³, R⁴, and R⁵ are the same or different alkyl, aryl, or vinyl groups.

In step A, the alcohol, as the raw material for alcoholysis reaction, also acts as a solvent; the ratio of the total mass of alcohol and solvent to the mass of chlorosilane monomer in step A is 2-9:1.

Preferably, the solvent is an inert organic solvent, such as toluene, xylene, PMA, CAC, etc; alcohols are alcohol solvents such as methanol, ethanol, isopropanol, n-butanol, etc; inert organic solvents are mixed with alcohol solvents in a mass ratio of 2-60:1.

Preferably, water is 1-8 times the mass of chlorosilane monomer.

The mechanism of the present invention is as follows:

Epoxy resin has good adhesion to various metal and non-metal materials such as steel, iron, aluminum, copper, etc. Acrylic resin has good water and chemical resistance, ideal weather resistance, fast drying, high hardness, and polyester resin has good adhesion, high hardness, and ideal solvent resistance. In the present invention, polyester resin, epoxy resin, and acrylic resin are used to react with polysiloxane oligomers to prepare an interpenetrating network type organic silicon resin, such that the interpenetrating network type organic silicon resin has the advantages of organic resin and organic silicon resin respectively, and overcomes the shortcomings of poor adhesion of organic silicon resin to copper material. The comprehensive performance of the resin is improved, and a new type of practical resin with ideal weather resistance, solvent resistance, high temperature resistance and hardness can be prepared. The adhesive force to non-ferrous metals, especially metal materials such as copper parts, copper materials, copper alloys and aluminum products, is significantly improved, non-ferrous metals are protected, and the service life of non-ferrous metals is prolonged.

The present invention is further described in detail in conjunction with, but not limited to, the following examples.

### Example 1

In this example, methyltrichlorosilane, dimethyldichlorosilane, phenyltrichlorosilane, and silicon tetrachloride were used as raw materials and isopropanol and xylene were used as solvents to prepare polysiloxane oligomer, including 37.4 g of methyltrichlorosilane, 232.1 g of phenyltrichlorosilane, 77.4 g of dimethyldichlorosilane, and 8.5 g of silicon tetrachloride, as well as 856 g of water for solvent, 124 g of isopropanol, and 700 g of xylene.

Methyl trimethoxysilane was selected as the alkoxysilane, with a dosage of 20.4 g.

Select the polyester resin prepared by condensation of trimethylolpropane, terephthalic acid, ethylene glycol, and phthalic acid in a mass ratio of 6:6:1:5 under the action of organic tin catalyst at 150-240° C. for 5-7 hours. The polyester resin has hydroxyl content of 16.5%, PMA as the solvent, the solid content of 80%, the acid value less than 10 mg KOH/g, and the number average molecular weight of 1000-15000.

E-51 was selected as the epoxy resin.

Thermosetting acrylic resin with an acid value of 10 mg KOH/g and a hydroxyl value of 60 mg KOH/g was selected as acrylic resin.

Stannous octoate, lead isooctanoate, tetrabutyl titanate, and dibutyltin diacetate were mixed in a mass ratio of 7:4:2:3 to prepare polymerization reaction catalyst.

Cyclohexanone, xylene, PMA and ethyl acetate were selected as the polymerization reaction solvent.

Benzol melamine formaldehyde resin was selected as the amino resin.

The specific preparation method was as follows:
A. 856 g of water, 124 g of isopropanol, and 700 g of xylene were added in a three necked flask with a thermometer, constant pressure dropping funnel, and mechanical mixer, heat the water bath to 15° C. while mixing, and added dropwise a mixture of 37.4 g of methyltrichlorosilane, 232.1 g of phenyltrichlorosilane, 77.4 g of dimethyldichlorosilane, and 8.5 g of silicon tetrachloride at 15-55° C. within 4 hours. After the dropwise addition was completed, stirred for reaction for 2 hours and separated the acid. The silanol layer was washed with water until neutral, decolorized and filtered, and vacuum distilled to a solid content of 65% to obtain the polysiloxane oligomer.
B. 302 g of prepared polysiloxane oligomer was taken, and mixed with 20.4 g of methyltrimethoxysilane, 79 g of polyester resin, 47 g of E-51, 61 g of acrylic resin, 15 g of cyclohexanone, 13 g of xylene, 32 g of PMA, and 29 g of ethyl acetate in a three necked flask, heat to 80° C. while stirring until the materials were evenly mixed, then added 1.05 g of polymerization reaction catalyst, kept at 80-85° C. for 3 hours, heat up to 146° C. for reflux reaction for 5 hours, added 50 g of PMA, cooled down to 80° C., added 28 g of benzol melamine formaldehyde resin, stirred for 30 minutes, added PMA to adjust the resin solid content to 50%, and obtained a light yellow transparent interpenetrating network organic silicon resin.

### Example 2

In this example, select methyl trichlorosilane, dimethyl dichlorosilane, methyl phenyl dichlorosilane, phenyl trichlorosilane, ethanol, and PMA as raw materials to prepare polysiloxane oligomers, including 23.9 g of methyl trichlorosilane, 274.3 g of phenyl trichlorosilane, 129.1 g of dimethyl dichlorosilane, and 34 g of methyl phenyl dichlorosilane. Select water, ethanol, and PMA as solvents, including 863 g of water, 201 g of ethanol, and 984 g of PMA.

Methyl triethoxysilane was selected as the alkoxysilane.

Select the polyester resin prepared by condensation of trimethylolpropane, terephthalic acid, and phthalic acid in a mass ratio of 5:1:3 under the action of organic tin catalyst at 140-250° C. for 4-5 hours. The polyester resin has hydroxyl content of 15% and a solid content of 80%.

CYD-217 epoxy resin was selected as the epoxy resin.

Thermosetting acrylic resin with an acid value of 10 mg KOH/g and a hydroxyl value of 60 mg KOH/g was selected as acrylic resin.

Cobalt isooctanoate, isopropyl titanate, lead octanoate, and cobalt cycloalkanoate were mixed in a mass ratio of 6:3:2:4 to prepare polymerization reaction catalyst.

Butyl acetate, butanol, PMA and cyclohexanone were used as the polymerization reaction solvent.

Ethanol etherified urea formaldehyde resin was selected as the amino resin.

The specific preparation method was as follows:
A. 863 g of water, 201 g of ethanol, and 984 g of PMA were added into a three necked flask with a thermometer, a constant pressure dropping funnel, and mechanical mixer. While stirring, heat the flask to 10° C. in a water bath, a mixture of 23.9 g of methyltrichlorosilane, 274.3 g of phenyltrichlorosilane, 129.1 g of dimethyldichlorosilane, and 34 g of methylphenyldichlorosilane was add dropwise at 10-55° C. within 5 hours. After the dropwise addition was complete, continue stirring for 1 hour and then separate the acid. The silanol layer was washed with water until neutral, decolorized and filtered, and vacuum distilled to a solid content of 65% to obtain polysiloxane oligomers.
B. 250 g of prepared polysiloxane oligomer was taken, mixed with 26.7 g of methyltriethoxysilane, 140 g of polyester resin, 15 g of CYD-217 epoxy resin, 31 g of acrylic resin, 25 g of butyl acetate, 13 g of cyclohexanone, 18 g of butanol, and 27 g of PMA in a three necked flask, stirred evenly, heat up to 65° C., added 1.82 g of polymerization reaction catalyst, kept at 65-80° C. for 4 hours, heat up to 140-150° C. for reflux reaction for 6 hours, added 50 g of PMA, cooled down to 85° C., added 15 g of ethanol etherified urea formaldehyde resin, stirred for 40 minutes, added PMA to adjust the resin solid content to 50%, and obtained a colorless and transparent interpenetrating network organic silicon resin.

### Example 3

The only difference from Example 1 was that the mass ratio of polysiloxane oligomers, polyester resin, epoxy resin, and acrylic resin was adjusted, and other steps and conditions are the same as Example 1. The adjustment ratio and test results are shown in Table 1 below.

TABLE 1
Mass Ratio of Raw Materials and Test Results of Example 3

| | | Coating | Adhesion | Reference |
|---|---|---|---|---|
| Group | Mass ratio | thickness | force | standard |
| A | 1:0.05:0.02:0.05 | 25 μm | Level 4 | GB1720- |
| B | 1:0.25:0.05:0.10 | 25 μm | Level 2 | 79(89) (With |
| C | 1:0.96:0.64:0.81 | 25 μm | Level2 | copper plate |
| D | 1:1.1:0.8:1 | 25 μm | Level 3 | as the |
| | | | | substrate) |

According to Table 1, under the same testing conditions, products with different mass ratios have a significant impact on the adhesion of copper materials. Therefore, the preferred mass ratio of polysiloxane oligomers, polyester resins, epoxy resins, and acrylic resins in the present invention is 1:(0.25˜0.96):(0.05˜0.64):(0.10˜0.81).

### Comparative Example 1

The only difference from Example 1 was that the epoxy resin was removed, and the other steps and conditions were the same as Example 1.

### Comparative Example 2

The only difference from Example 1 was that the acrylic resin was removed, and the other steps and conditions were the same as Example 1.

### Comparative Example 3

The only difference from Example 1 was that the polyester resin was removed, and the other steps and conditions were the same as Example 1.

### Comparative Example 4

The only difference from Example 1 was that the polymerization reaction solvent was removed, and the other steps and conditions were the same as Example 1.

### Comparative Example 5

The only difference from Example 1 was that the low-temperature pre-reaction step was removed, and the other steps and conditions were the same as Example 1.

In accordance with the above standard GB1720-79 (89), adhesion tests were conducted on the interpenetrating network type silicone resin obtained in Examples 1-2 and Comparative Examples 1-5 using purple copper plate as the substrate. The results are shown in Table 2.

TABLE 2
Test Results of Interpenetrating Network Organic Silicon Resin
Obtained from Examples 1-2 and Comparative Examples 1-5

| | | Adhesion | Coating |
|---|---|---|---|
| | Appearance | force | thickness |
| Example 1 | Light yellow | Level 1 | 25 μm |
| | transparent liquid | | |
| Example 1 | Light yellow | Level 1 | 25 μm |
| | transparent liquid | | |
| Comparative | Light yellow | Level 5 | 25 μm |
| Example 1 | transparent liquid | | |
| Comparative | Light yellow | Level 4 | 25 μm |
| Example 2 | transparent liquid | | |
| Comparative | Light yellow | Level 4 | 25 μm |
| Example 3 | transparent liquid | | |
| Comparative | Light yellow slightly | Level 5 | 25 μm |
| Example 4 | turbid liquid | | |
| Comparative | Light yellow slightly | Level 5 | 25 μm |
| Example 5 | turbid liquid | | |

As shown in Table 2, in the present invention, polyester resin, epoxy resin, and acrylic resin are used to react with polysiloxane oligomers to prepare an interpenetrating network type organic silicon resin, such that the interpenetrating network type organic silicon resin has the advantages of organic resin and organic silicon resin respectively, and overcomes the shortcomings of poor adhesion of organic silicon resin to copper material. The comprehensive performance of the resin is improved, and the synergistic effect between raw materials effectively improves their adhesion to non-ferrous metals, especially copper materials.

Compared with the prior art, the present invention provides an interpenetrating network type organic silicon resin and a preparation method therefor, and the organic silicon resin includes at least one or more of polysiloxane oligomers, which is reacted with hydroxyl-containing polyester resin, epoxy resin, and acrylic resin under the action of a polymerization reaction catalyst and a mixed solvent, pre-reacted at 50-100° C. for 2-6 hours, then heated to 130-155° C. for 4-8 hours, added with solvent to cool to 50-90° C., then added with amino resin to adjust solid content to 50%, and finally the colorless to light yellow transparent interpenetrating network type organic silicon resin described in the present invention is obtained.

The specific embodiments of the present invention described above do not constitute limitations on the scope of protection hereof. Any other corresponding changes and modifications made based on the technical concept of the present invention shall be included within the scope of protection of the claims hereof.

What is claimed is:

1. An interpenetrating network type organic silicon resin, wherein raw materials of the interpenetrating network type organic silicon resin comprise a polysiloxane oligomer, an alkoxysilane, a polyester resin, an epoxy resin, an acrylic resin, a polymerization reaction catalyst, a polymerization reaction solvent and an amino resin, wherein a mass ratio of the polysiloxane oligomer to the polyester resin to the epoxy resin to the acrylic resin is 1:(0.25-0.96):(0.05-0.64):(0.10-0.81);
a mass fraction of the alkoxysilane in the polysiloxane oligomer is 0.5-18%;
and the amino resin accounts for 1-25% of a total mass of polysiloxane oligomer, polyester resin, epoxy resin and acrylic resin.

2. The interpenetrating network type organic silicon resin according to claim 1, wherein a structural formula of the alkoxysilane is R¹Si(OR²)₃;
wherein R¹ is a hydrocarbon group; R² is methyl, ethyl, propyl, or butyl.

3. The interpenetrating network type organic silicon resin according to claim 1, wherein a structural formula of polysiloxane oligomer is: (R³SiO_{3/2})ₐ·(R⁴R⁵SiO_{2/2})_{b}·(SiO₂)_{c}·R⁶;
wherein R³SiO₃₂, R⁴R⁵SiO_{2/2}, and SiO₂ represent T unit siloxanes, D unit siloxanes, and Q unit siloxanes, respectively; R³, R⁴, and R⁵ are the same or different alkyl, aryl, or vinyl groups, R⁶ is an alkoxy functional group or hydroxyl group, and a, b, and c are integers greater than or equal to 0 but not all 0.

4. The interpenetrating network type organic silicon resin according to claim 1, wherein a hydroxyl content of the polyester resin is 5%-18%, a solid content is 80%, a acid value is less than 10 mg KOH/g, and a number average molecular weight is 1000-15000; the epoxy resin comprises bisphenol A type epoxy resin, with an epoxy equivalent of 100-6000 g/eq.

5. The interpenetrating network type organic silicon resin according to claim 1, wherein the acrylic resin comprises a thermosetting hydroxy acrylic resin, with an acid value of less than 20 mg KOH/g and a hydroxy value of 50-260 mg KOH/g.

6. The interpenetrating network type organic silicone resin according to claim 1, wherein a mass fraction of the polymerization reaction catalyst to the polysiloxane oligomer is 0.1%-1.5%; the polymerization reaction catalyst is a mixture of at least three types of metal organic carboxylate, titanate, and organic tin catalysts.

7. The interpenetrating network type organic silicon resin according to claim 6, wherein the metal carboxylate comprises one or more of zinc cycloalkanoate, zinc isooctanoate, cobalt cycloalkanoate, cobalt isooctanoate, lead isooctanoate, lead cycloalkanoate, lead octanoate, manganese cycloalkanoate, and stannous octanoate; the titanates comprise one or more of tetrabutyl titanate and tetraisopropyl titanate; the organic tin catalysts comprise one or more of dibutyltin dilaurate, dioctyltin dilaurate, dibutyltin dibutanoate, dioctyltin diacetate, dibutyltin diacetate, and dibutyltin Bis(2,4-pentanedionate).

8. The interpenetrating network type organic silicon resin according to claim 1, wherein the polymerization reaction solvent accounts for 10-60% of a total mass of polysiloxane oligomer, polyester resin, epoxy resin, and acrylic resin; the polymerization reaction solvent comprises a mixed solvent composed of any two or more of cyclohexanone, n-butanol, butyl acetate, ethyl acetate, PMA, CAC, IMP, MIBK, isophorone, xylene, DBE solvent, isopropanol, acetone, toluene, and diethyl ether.

9. The preparation method of interpenetrating network type organic silicon resin according claim 1, comprising the following steps:
(1) mix in proportion polysiloxane oligomers, alkoxysilane, polyester resin, epoxy resin, acrylic resin, polymerization reaction catalyst, and first polymerization solvent to obtain a mixture;
(2) pre-react the mixture at 50-100° C. for 2-6 hours, then heat to 130-155° C. for 4-8 hours, add a second polymerization reaction solvent and cool to 50-90° C., add amino resin, and then add a third polymerization reaction solvent to adjust solid content to 45-55%, and finally obtain the interpenetrating network type organic silicon resin.

10. The preparation method of interpenetrating network type organic silicon resin according to claim 9, wherein the preparation of the polysiloxane oligomer comprises the following steps:
mix chlorosilane monomers evenly and add them dropwise to a mixture of alcohol, water, and solvent for simultaneous alcoholysis and hydrolysis reactions;
after the reaction is complete, separate acidic water layer, wash silanol with water until neutral, decolorize and filter, and evaporate a portion of the solvent under reduced pressure to a solid content of 60-70% to obtain the polysiloxane oligomer.
